(19) United States
(12) Patent Application Publication
(10) Pub. No.: US 2012/0043286 A1
(43) Pub. Date: Feb. 23, 2012

(54) BICYCLE RACK

(75) Inventor: Bobby NOYES, Boulder, CO (US)

(73) Assignee: Rocky Mounts, Boulder, CO (US)

(21) Appl. No.: 13/184,122

(22) Filed: Jul. 15, 2011

Related U.S. Application Data
(60) Provisional application No. 61/375,388, filed on Aug. 20, 2010.

(51) Int. Cl. A47F 7/00; F16B 45/00; B23P 17/04

(52) U.S. Cl. 211/22; 29/428; 248/340

(57) ABSTRACT

A bicycle rack (100) and a hook mount (103) for a bicycle rack (100) are provided. The bicycle rack (100) includes one or more support arms (102). The hook mount (103) can be coupled to a support arm (102). The hook mount (103) includes a body (210), which comprises a first end (210a) adapted to be coupled to a support arm (102). The hook mount (103) also includes a second end (210b) opposite the first end (210a). The second end (210b) comprises a support channel (212) to receive at least a portion of a top tube (8) of a bicycle (7) such that the top tube (8) is located between the support channel (212) and the first end (210a).

### RELATED APPLICATION

This application claims the benefit of U.S. provisional application Ser. No. 61/375,388 filed on Aug. 20, 2010 entitled “Bicycle Rack”.

### TECHNICAL FIELD

The present invention relates to, bicycle racks, and more particularly, to a bicycle rack with one or more hook mounts for supporting one or more bicycles.

### BACKGROUND OF THE INVENTION

With the increasing popularity of cycling, the use of vehicle mounted bicycle racks has risen. Vehicle mounted bicycle racks come in a variety of configurations including roof mounted or rear mounted racks. Roof-mounted bicycle racks typically retain one or two bicycles by the bicycle's tire or fork. Conversely, rear-mounted racks can generally carry between one and four bicycles, although rear-mounted racks could carry more than four bicycles. Rear-mounted racks are typically one of two configurations. The first configuration straps or otherwise holds the rack on the rear of the vehicle, such as the trunk and/or bumper. The second configuration is a hitch-mounted system where a mounting frame of the rack engages a vehicle's rear hitch. While some rear-mounted racks retain the bicycles by the tires or forks in much the same way as the roof-mounted racks, most rear-mounted racks retain the bicycles by the bicycle's frame. Generally, the rear-mounted racks engage the bicycle's top tube and the bicycle's down tube or seat tube.

Examples of prior art rear-mounted bicycle racks are disclosed in U.S. Pat. Nos. 6,467,664; 6,840,418; and 6,988,645. As shown in these prior art patents, a support channel or saddle mount is provided, which is supported on a support arm of the rack's frame and is adapted to hold onto a bicycle's top tube. A stabilizer is also provided to retain the bicycle's down tube or seat tube and prevent the bicycle from swaying and damaging the bicycle or the vehicle. The stabilizers are rotatable with respect to the cradle in order to accommodate various bicycle configurations.

While the prior art rear-mounted bicycle racks can usually retain the bicycles adequately during travel, the prior art racks suffer from a serious inconvenience when loading or unloading the bicycles. As shown in the prior art racks, the bicycle's top tubes are always received in the support channel, which is located above of the support arms. Consequently, the bicycle's top tube is also located above the rack's support arms. As a result, in order to load and unload the bicycle onto and off from the rack, the bicycle must be lifted over the support arms. As can be appreciated, if more than one bicycle is loaded onto the rack, the multiple bicycles must be loaded and unloaded in sequential order with respect to their position on the support arms. Thus, bicycles located closer to the vehicle cannot be removed until all bicycles located further away from the vehicle have been removed. This creates an inconvenient situation for users who desire to load or remove inner bicycles from the rack without removing outer bicycles.

The present invention overcomes these and other problems and an advance in the art is achieved. The present invention provides a bicycle rack that includes one or more hook mounts that receive a portion of a bicycle's frame. The one or more hook mounts allow a bicycle to be mounted and/or removed without removing other bicycles on the rack.

### SUMMARY OF THE INVENTION

A hook mount for a bicycle rack is provided according to an embodiment of the invention. The bicycle rack includes one or more support arms. According to an embodiment of the invention, the hook mount includes a body and comprises a first end adapted to couple to a support arm of the one or more support arms. According to an embodiment of the invention, a second end opposite the first end comprises a support channel to receive at least a portion of a top tube of a bicycle such that the top tube is located between the support channel and the first end.

A bicycle rack for a bicycle including a top tube is provided according to an embodiment of the invention. The bicycle rack can include a mounting frame and one or more support arms coupled to the mounting frame. According to an embodiment of the invention, the bicycle rack further includes a hook mount comprising a body and including a first end coupled to a support arm of the one or more support arms. According to an embodiment of the invention, the hook mount also includes a second end comprising a support channel to receive at least a portion of the top tube of the bicycle such that the top tube is located between the one or more support arms and the support channel.

A method for mounting a bicycle onto a bicycle rack is provided according to an embodiment of the invention. The bicycle rack includes one or more support arms and a hook mount coupled to a support arm of the one or more support arms at a first end. The hook mount further includes a support channel at a second end. According to an embodiment of the invention, the method comprises a step of positioning a top tube of the bicycle on the support channel such that the top tube is located between the one or more support arms and the support channel.

### BRIEF DESCRIPTION OF THE DRAWINGS

FIG. 1 shows a bicycle rack according to an embodiment of the invention.

FIG. 2 shows a bicycle hook mount according to an embodiment of the invention.

FIG. 3 shows the bicycle rack according to another embodiment of the invention.

### DETAILED DESCRIPTION OF THE INVENTION

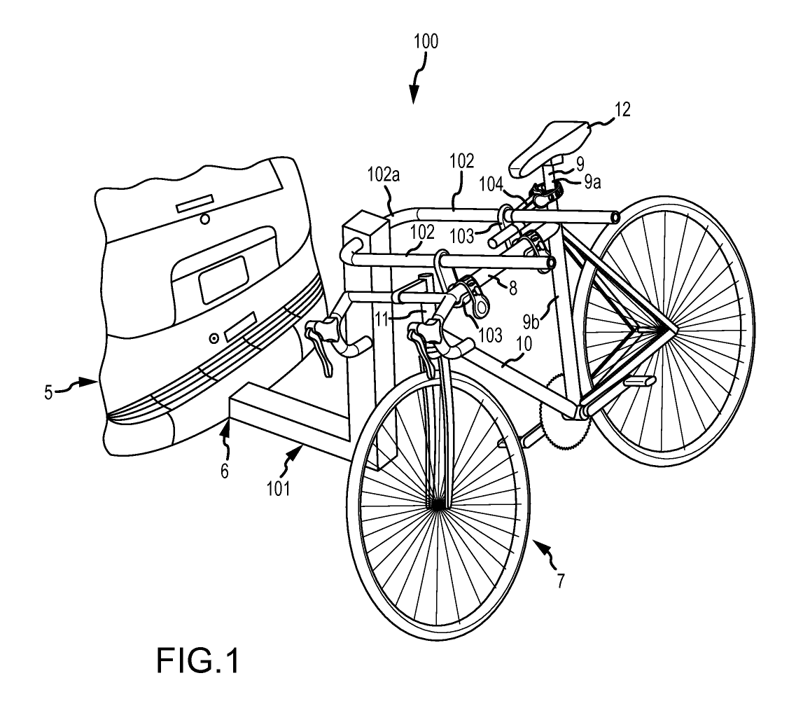

FIGS. 1-3 and the following description depict specific examples to teach those skilled in the art how to make and use the best mode of the invention. For the purpose of teaching inventive principles, some conventional aspects have been simplified or omitted. Those skilled in the art will appreciate variations from these examples that fall within the scope of the invention. Those skilled in the art will appreciate that the features described below can be combined in various ways to form multiple variations of the invention. As a result, the invention is not limited to the specific examples described below, but only by the claims and their equivalents.

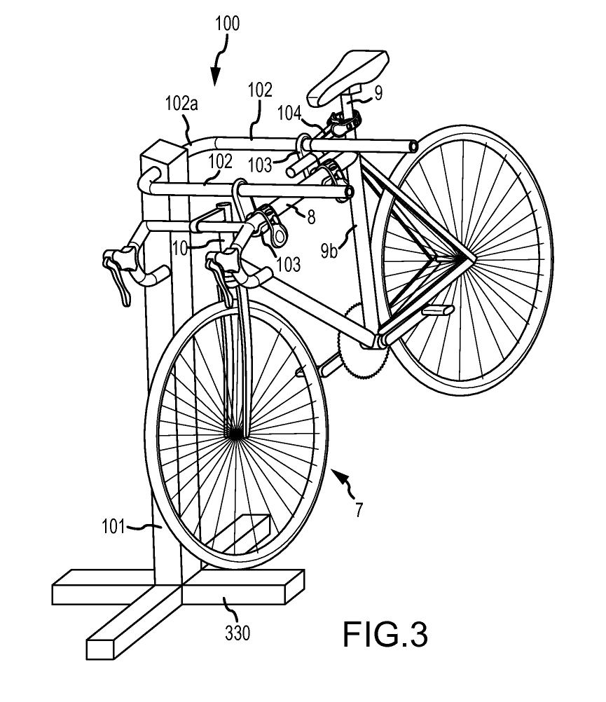

FIG. 1 shows a bicycle rack 100 according to an embodiment of the invention. According to an embodiment of the invention, the bicycle rack 100 comprises a vehicle-mounted system. However, in other embodiments, the bicycle rack 100 may be designed as a stationary system used for storing bicycles (See FIG. 3, for example). The embodiment shown in FIG. 1 comprises a hitch-mounted system; however, the bicycle rack 100 could just as easily be implemented as a trunk-mounted system as is well known in the art from the previously mentioned U.S. Pat. Nos. 6,467,664 and 6,840,418. According to an embodiment of the invention, the bicycle rack 100 comprises a support frame 101. In the embodiment shown, the support frame 101 is configured to contact a vehicle 5. In the embodiment shown, the support frame 101 engages a rear hitch assembly 6 of the vehicle 5. However, as mentioned above, the support frame 101 could just as easily comprise a trunk-mounted system. The particular configuration of the support frame 101 could be chosen from a wide variety of available bicycle rack frames and is not important for the purpose of the present invention, and should in no way limit the scope of the invention.

According to an embodiment of the invention, the bicycle rack 100 further comprises one or more support arms 102. The one or more support arms 102 are coupled to and extend from the support frame 101. The one or more support arms 102 may be held in position with respect to the support frame 101 using welding, brazing, bonding, mechanical fasteners, such as removable pins, friction fit, etc. Therefore, the support frame 101 can be provided to mount the support arms 102 to a vehicle, such as the vehicle 5 or to space the support arms 102 away from the ground, such as shown in FIG. 3. According to an embodiment of the invention, the one or more support arms 102 extend from the support frame 101 in an approximately horizontal direction, i.e., approximately parallel to the ground. In some other embodiments, the one or more support arms 102 may be angled away from horizontal. However, as can be appreciated, because the support arms 102 are provided to support one or more bicycles, it is preferable to have the support arms 102 extend substantially parallel to the ground. In the embodiment shown, the support arms 102 comprise a generally U-shaped configuration with a base 102a coupled to the support frame 101 that connects the two arms 102.

According to an embodiment of the invention, the support arms 102 are adapted to couple and support one or more bicycle hook mounts 103. While one bicycle hook mount 103 is shown on each support arm 102, it should be appreciated that more than one bicycle hook mount 103 may be provided on each arm 102. For example, in one embodiment, four hook mounts 103 are provided on each support arm 102 in order to accommodate four bicycles. The bicycle hook mounts 103 are configured to receive a first component of a bicycle 7. According to some embodiments, the bicycle hook mounts 103 are configured to receive a component of a bicycle's frame. The bicycle's frame may comprise a top tube 8, a seat tube 9, a down tube 10, and a handlebar tube 11. In some embodiments, the seat tube 9 may be separated between a first tube 9a and a second tube 9b in order to adjust the height of the seat 12 as is generally known in the art. For purposes of the present invention, when referring to the seat tube 9, the seat tube may comprise the first or second tube 9a, 9b.

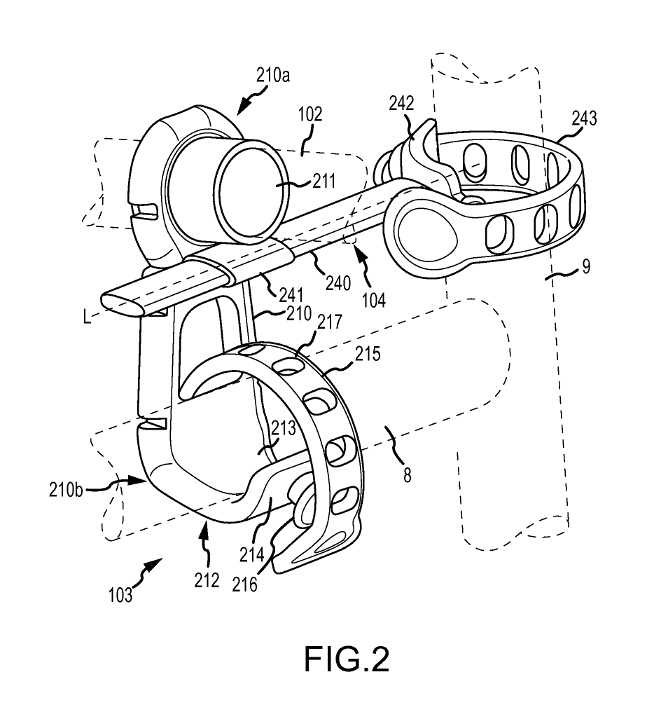

According to an embodiment of the invention, the bicycle hook mounts 103 are adapted to receive a top tube 8 of the bicycle 7. According to an embodiment of the invention, the bicycle hook mounts 103 are coupled to the support arms 102 such that a portion of the bicycle 7, such as the top tube 8, is received by the hook mounts 103 and positioned between a support channel 212 (See FIG. 2) of the bicycle hook mounts 103 and the support arms 102. Advantageously, if a second bicycle (not shown) is mounted on the support arms 102 further away from the support frame 101 with similar bicycle hook mounts, the first bicycle can be removed without removing the second bicycle. In some embodiments, the support arms 102 may comprise a length suitable to receive two or more bicycles, such as the bicycle 7. More preferably, the support arms 102 may comprise a length suitable to receive four or more bicycles, for example.

According to an embodiment of the invention, one or both of the bicycle hook mounts 103 can include a stabilizing arm 104. While the bicycle hook mounts 103 can be configured to receive a top tube 8 of a bicycle 7, the stabilizing arm 104 can be configured to engage and retain a seat tube 9 or a handlebar tube 11 of the bicycle 7. In other words, while the bicycle hook mounts 103 engage a first component of the bicycle that extends in a horizontal direction, i.e., in a plane parallel to the plane of the longitudinal direction of the support arms 102, the stabilizing arm 104 engages a second component of the bicycle 7 that extends in a direction generally perpendicular to the support arms 102. In other bicycle configurations, the second component may not extend perpendicular to the support arms 102, but rather, may extend at an angle. Therefore, the present invention should not be limited to situations where the second component extends perpendicular to the support arms 102. The bicycle hook mount 103 and stabilizing arm 104 are shown in detail in FIG. 2.

FIG. 2 shows a bicycle hook mount 103 according to an embodiment of the invention. According to an embodiment of the invention, the bicycle hook mount 103 can comprise a body 210. According to an embodiment of the invention, the body 210 can be coupled to a support arm 102 at a first end 210a. In the embodiment shown, an aperture 211 is formed in the first end 210a of the body 210. The aperture 211 can be sized and adapted to receive at least a portion of a support arm 102 as shown in FIG. 1 and, which is shown in dashed lines in FIG. 2. The aperture 211 may be lined with a compressible material, such as rubber, neoprene, or foam, for example. Therefore, the inner diameter of the aperture 211 may be slightly smaller than the outer diameter of the support arm 102 in order to hold the hook mount 103 on the support arm 102 using a friction fit. However, with the aperture 211 having a smaller diameter, if the inner surface of the aperture 211 can compress to increase the inner diameter size, the support arm 102 can still be received within the aperture 211. In other embodiments, the aperture 211 may be held onto the support arm 102 according to other methods such as, collars, pins, bolts, adhesives, etc. Therefore, the particular method of retaining the aperture 211 on the support arm 102 should in no way limit the scope of the present invention.

While the aperture 211 and support arms 102 are shown and described as comprising a substantially cylindrical shape, it should be appreciated that the components may comprise other shapes and the particular embodiment shown should in no way limit the scope of the present invention. For example, the aperture 211 and support arms 102 may comprise a rectangular or some irregular shape that would substantially prevent the hook mounts 103 from rotating about the support arms 102 without requiring a friction fit. Furthermore, it should be appreciated, that in other embodiments, the apertures 211 may be omitted and the first end 210a of the body 210 of the hook mount 103 may be coupled to a support arm 102 using other known methods, such as adhesives, brazing, welding, bonding, mechanical fasteners, etc.

According to an embodiment of the invention, the hook mount 103 further comprises a support channel 212 provided at a second end 210b of the body 210 spaced apart from the first end 210a. In the embodiment shown, the support channel 212 comprises a concave receiving surface 213 that ends at a lip 214. As can be appreciated, a portion of a bicycle 7, such as the top tube 8 can be received by the support channel 212 and rest on the receiving surface 213. The lip 214 can at least partially retain the top tube 8 within the support channel 212 by requiring the top tube 8 to rise above the lip 214 in order to be removed from the support channel 212.

According to an embodiment of the invention, the receiving surface 213 of the support channel 212 faces the first end 210a of the body 210 and thus, the support arm 102. Consequently, when at least a portion of the top tube 8 of the bicycle 7 is received by the support channel 212, the top tube 8 of the bicycle 7 is positioned between the support channel 212 and the first end 210a of the body 210. When the first end 210a is coupled to the support arm 102, the top tube 8 is positioned between the support channel 212 and the support arm 102 of the bicycle rack 100. This is in contrast to prior art bicycle racks where the saddle or support channel that receives the bicycle faces away from the support arm. Therefore, unlike prior art systems, which place the top tube of the bicycle above the support arm, the support arm 102 of the present invention will typically not interfere with loading and/or unloading of bicycles onto and off from the hook mount 103.

According to an embodiment of the invention, the hook mount 103 can further comprise one or more retaining members 215. At least one end of the retaining member 215 can be removably coupled to the support channel 212 as described below. In the embodiment shown, the end proximate the lip 214 is removably coupled to the support channel 212. While a single retaining member 215 is shown in FIG. 2, it should be appreciated that the hook mount 103 may include more than one retaining member 215. The retaining member 215 can be provided to retain a portion of the bicycle 7 within the support channel 212. Therefore, the retaining member 215 can prevent a bicycle from falling out of the support channel 212 while the vehicle 5 is moving, for example.

In the embodiment shown, a user can wrap the retaining member 215 at least partially around the top tube 8 of the bicycle 7, after positioning the top tube 8 in the support channel 212. The retaining member 215 may be formed from a deformable material, such as rubber or the like, for example that can be stretched around the top tube 8 and secured to the support channel 212 via a protrusion 216. The user can stretch the retaining member 215 so that one of the one or more holes 217 formed in the retaining member 215 deforms to fit over a ledge 230 at the end of the protrusion 216, for example. Once the hole is over the ledge 230, the user can release the retaining member 215 and allow the hole 217 to return to its previously un-deformed shape, thereby securing the retaining member 215 on the protrusion 216 and around the tube 8. Those skilled in the art will readily recognize alternative arrangements for securing the retaining member 215, such as snaps, hook and loop fastening systems, i.e, Velcro®, mechanical clamps, tooth arrangement, etc. Therefore, the present invention should not be limited to a hole/protrusion securing arrangement. In some embodiments, the end of the retaining member 215 proximate the body 210 may be secured using similar systems or may be substantially permanently coupled to the body, such as being molded into the body 210.

As mentioned above, in some embodiments, the hook mount 103 can further include a stabilizing arm 104. In the embodiment shown in FIG. 1, only one of the hook mounts includes a stabilizing arm 104. However, in other embodiments, the hook mount 103 coupled to both of the support arms 102 can include a stabilizing arm 104. According to an embodiment of the invention, the stabilizing arm 104 is adapted to restrict movement of the bicycle 7 about the top tube 8 as it rests in place in the support channel 212. According to an embodiment of the invention, while the support channel 212 receives at least a portion of a first component of the bicycle 7, the stabilizing arm 104 is configured to receive at least a portion of a second component of the bicycle 7. For example, the stabilizing arm 104 may be configured to engage the seat tube 9 or the handlebar tube 11. Alternatively, the stabilizing arm 104 may be configured to engage the down tube 10.

In the embodiment shown, the stabilizing arm 104 comprises a shaft 240 sized and shaped to engage a sleeve 241, which extends from the body 210. According to an embodiment of the invention, the shaft 240 can be slidable within the sleeve 241. Advantageously, the shaft and sleeve configuration allows the stabilizing arm 104 to move along the longitudinal axis, L, of the shaft 240 with respect to the body 210. In the embodiment shown, the stabilizing arm 104 is movable with respect to the body 210 in a direction perpendicular to the seat tube 9. Therefore, in contrast to the previously mentioned prior art bicycle racks where a stabilizing means is rotatable with respect to the channel or the support arm, the present invention limits movement of the stabilizing arm 104 along the longitudinal axis, L, of the shaft 240 in order to increase the stabilization realized by the bicycle rack 100.

According to an embodiment of the invention, the stabilizing arm 104 further comprises a cradle 242. The cradle 242 is coupled to the shaft 240 and is configured to contact a second component of the bicycle 7, which is substantially perpendicular to the first component. For example, the second component can comprise the seat tube 9 or the handlebar tube 11 of the bicycle 7, which as shown in the figures is substantially perpendicular to the top tube 11 of the bicycle 7. Therefore, the cradle 242 can comprise a concave face that can at least partially conform to the shape of the tube, for example. The cradle 242 may include rubber, foam, or some other partially compressible material to cushion the seat tube 9 and prevent the cradle 242 from scratching or otherwise damaging the bicycle 7. According to an embodiment of the invention, once the user has positioned the first component of the bicycle 7, for example, the top tube 8 in the support channel 212, the shaft 240 of the stabilizing arm 104 can be moved into position so the cradle 242 can contact the second component of the bicycle 7. The particular order in which the bicycle 7 is mounted onto the bicycle rack 100 should not limit the scope of the present invention.

According to an embodiment of the invention, the cradle 242 further comprises a retaining member 243. The retaining member 243 can operate in a manner similar to the retaining member 215 described above in order to retain the bicycle's seat tube 9 against the cradle 242. Therefore, a user can wrap the retaining member 243 at least partially around the tube received by the cradle 242 to retain the tube against the cradle 242.

With the seat tube 9 or the handlebar tube 11 secured in the cradle 242, the bicycle 7 is substantially restricted from swaying within the support channel 212 as the vehicle 5 is moving, for example. Therefore, damage to the bicycle 7 and the vehicle 5 is substantially reduced.

FIG. 3 shows the bicycle rack 100 according to another embodiment of the invention. While the previously discussed embodiments depict the mounting frame 101 being mountable on a vehicle, such as the vehicle 5, the mounting frame 101 shown in FIG. 3 comprises a base 330 that stabilizes the mounting frame 101 in a substantially vertical orientation. Therefore, the bicycle rack 100 shown in FIG. 3 may be configured to store one or more bicycles when not in use.

The present invention as described above provides a bicycle rack 100 and a hook mount 103 for a bicycle rack 100. The present invention allows users to load and unload individual bicycles without interfering with other bicycles already on the bicycle rack 100. This is made possible by a unique hook mount 103 that positions the top tube 8 of the bicycle 7 below the support arms 102 rather than above the support arms 102 as in the prior art. Furthermore, the present invention provides a stabilizing arm 104 that slides relative to the body 210 of the hook mount 103 rather than rotating relative to the hook mount 103. Therefore, the stabilizing arm 104 can extend or retract to accommodate a variety of different bicycle configurations.

The detailed descriptions of the above embodiments are not exhaustive descriptions of all embodiments contemplated by the inventors to be within the scope of the invention. Indeed, persons skilled in the art will recognize that certain elements of the above-described embodiments may variously be combined or eliminated to create further embodiments, and such further embodiments fall within the scope and teachings of the invention. It will also be apparent to those of ordinary skill in the art that the above-described embodiments may be combined in whole or in part to create additional embodiments within the scope and teachings of the invention.

Thus, although specific embodiments of, and examples for, the invention are described herein for illustrative purposes, various equivalent modifications are possible within the scope of the invention, as those skilled in the relevant art will recognize. The teachings provided herein can be applied to other mounting systems, and not just to the embodiments described above and shown in the accompanying figures. Accordingly, the scope of the invention should be determined from the following claims.

We claim:

1. A hook mount (103) for a bicycle rack (100) including one or more support arms (102), the hook mount (103) including a body (210) and comprising:
a first end (210a) adapted to couple to a support arm of the one or more support arms (102); and
a second end (210b) opposite the first end (210a) comprising a support channel (212) to receive at least a portion of a top tube (8) of a bicycle (7) such that the top tube (8) is located between the support channel (212) and the first end (210a).

2. The hook mount (103) of claim 1, further comprising one or more retaining members (215) with at least one end removably coupled to the support channel (212) and configured to wrap at least partially around the top tube (8) when at least a portion of the top tube (8) is received by the support channel (212).

3. The hook mount (103) of claim 2, further comprising a protrusion (216) formed on the support channel (212) to retain a portion of a retaining member of the one or more retaining members (215).

4. The hook mount (103) of claim 1, further comprising an aperture (211) formed in the first end (210a) to receive at least a portion of the support arm (102).

5. The hook mount (103) of claim 1, further comprising a stabilizing arm (104) adapted to receive at least a portion of a second component of the bicycle (7).

6. The hook mount (103) of claim 5, wherein the stabilizing arm (104) comprises a shaft (240) and wherein the body (210) further includes a sleeve (241) to receive at least a portion of the shaft (240).

7. The hook mount (103) of claim 6, wherein the shaft (240) is movable within the sleeve (241) along a longitudinal axis, L, of the shaft (240).

8. The hook mount (103) of claim 5, wherein the stabilizing arm (104) further comprises a cradle (242) to receive at least a portion of the second component of the bicycle (7).

9. The hook mount (103) of claim 8, further comprising a retaining member (243) coupled to the cradle (242) to retain the second component against the cradle (242).

10. A bicycle rack (100) for a bicycle (7) including a top tube (8), comprising:
a mounting frame (101);
one or more support arms (102) coupled to the mounting frame (101);
a hook mount (103) comprising a body (210) and including:
a first end (210a) coupled to a support arm (102) of the one or more support arms (102); and
a second end (210b) comprising a support channel (212) to receive at least a portion of the top tube (8) of the bicycle (7) such that the top tube (8) is located between the one or more support arms (102) and the support channel (212).

11. The bicycle rack (100) of claim 10, further comprising one or more retaining members (215) with at least one end removably coupled to the support channel (212) and configured to wrap at least partially around the top tube (8) when the top tube (8) is received by the support channel (212).

12. The bicycle rack (100) of claim 11, further comprising a protrusion (216) formed on the support channel (212) to retain a portion of a retaining member of the one or more retaining members (215).

13. The bicycle rack (100) of claim 10, further comprising an aperture (211) formed in the first end (210a) of the hook mount (103) to receive at least a portion of the support arm (102).

14. The bicycle rack (100) of claim 10, wherein the hook mount (103) further comprises a stabilizing arm (104) adapted to receive at least a portion of a second component of the bicycle (7).

15. The bicycle rack (100) of claim 14, wherein the stabilizing arm (104) comprises a shaft (240) and wherein the body (210) further includes a sleeve (241) to receive at least a portion of the shaft (240).

16. The bicycle rack (100) of claim 15, wherein the shaft (240) is movable within the sleeve (241) along a longitudinal axis of the shaft (240).

17. The bicycle rack (100) of claim 14, wherein the stabilizing arm (104) further comprises a cradle (242) to receive at least a portion of the second component of the bicycle (7).

18. The bicycle rack (100) of claim 17, further comprising a retaining member (243) coupled to the cradle (242) to retain the second component against the cradle (242).

19. A method for mounting a bicycle onto a bicycle rack including one or more support arms and a hook mount coupled to a support arm of the one or more support arms at a first end and including a support channel at a second end, comprising a step of:
positioning a top tube of the bicycle on the support channel such that the top tube is located between the one or more support arms and the support channel.

20. The method of claim 19, further comprising a step of engaging at least a portion of a second component of the bicycle with a stabilizing arm.
